(19) United States
(12) Patent Application Publication
(10) Pub. No.: US 2024/0158620 A1
(43) Pub. Date: May 16, 2024

(54) Films Manufactured with Post-Consumer Recycled Plastic and Related Methods

(71) Applicant: Dover Chemical Corporation, Dover, OH (US)

(72) Inventors: Michael Jakupca, Canton, OH (US); Shawn Cook, Canton, OH (US); Matt Fender, Dundee, OH (US); Michael Davies, Strensham (GB)

(73) Assignee: Dover Chemical Corporation, Dover, OH (US)

(21) Appl. No.: 18/380,878

(22) Filed: Oct. 17, 2023

Related U.S. Application Data
(60) Provisional application No. 63/416,701, filed on Oct. 17, 2022.

(51) Int. Cl. C08L 23/06

(52) U.S. Cl. CPC C08L 23/06; C08L 2205/03; C08L 2207/066

(57) ABSTRACT

A product produced by a process having the step of creating a compounded product by compounding a composition having a formulation that includes: a first component that is a virgin-plastic-resin composition, a second component that is a composition that is a post-consumer recycled plastic resin, a post-industrial recycled plastic resin, or a combination thereof, and a third component that is a compound having the structure:

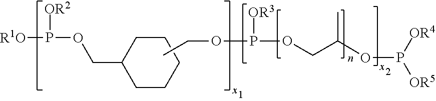

wherein each R¹, R², R³, R⁴ and R⁵ is independently selected and is a C₁₀-C₁₈ alkyl moiety; n is an integer ranging from 3 to 11; and the sum of X₁+X₂ is an integer ranging from 1-500.

### CROSS-REFERENECE TO RELATED APPLICATIONS

This patent application claims priority to U.S. provisional patent application No. 63/416,701 having a filing date of Oct. 17, 2022. The subject matter of U.S. provisional patent application No. 63/416,701 is incorporated into this application by reference.

### BACKGROUND OF THE INVENTION

There remains a need to use both: i) post-consumer recycled plastic (PCR plastic), and ii) post-industrial recycled plastic (PIR plastic) in manufacturing plastic films and other plastic articles. PCR plastic is plastic that has at least been previously molded or extruded into a useful commercial article and then subsequently recycled, and PIR plastic is plastic that has been melt processed at least once in a manufacturing environment, and often times more than once, typically because quality-control testing during manufacturing reveals substandard physical properties or other defects in the manufactured product. As a result of being previously processed, both PCR plastic and PIR plastic have at least one and sometimes a plurality of manufacturing heat-processing histories. These additional heat histories, relative to otherwise virgin (or prime) manufacturing materials, result in PCR plastic and PIR plastic being used in very limited amounts, and sometimes not at all, in end-use applications that require physical properties of a relatively higher quality; extruded plastic films are a non-limiting example of one such end-use application that requires physical properties of a relatively high quality.

In manufacturing plastic films, it is well known that virgin (or prime) plastic resins are commonly used in association with a variety of additives (and sometimes fillers) to ensure that a manufactured film has a thickness and physical properties suitable for a film product's intended end use.

But when manufacturing films using both virgin plastic resin in combination with one or more recycled plastic resins, i.e., PCR plastic or PIR plastic, as the amount of recycled plastic resin increases within a plastic-film formulation, a recycled-plastic-containing film having the same thickness as a film manufactured from all-virgin materials, typically displays relatively weakened or less desirable physical properties due to the recycled plastic's prior heat history(s) and associated imperfections.

To compensate for the recycled-plastic-containing film's relatively weakened or less desirable physical properties, films manufactured with both i) virgin plastic resin, and ii) PCR plastic or PIR plastic, are often relatively thicker than a film manufactured with all-virgin raw materials because an increased film thickness is necessary for a recycled-plastic-containing film to have substantially equivalent physical properties as a film manufactured from all-virgin materials. The minimum thickness that is needed for a recycled-plastic-containing film to have substantially equivalent physical properties as a film manufactured from all-virgin materials by the same process will be referred to herein either as a PCR-plastic-containing film's “minimum required thickness” or a PIR-plastic-containing film's “minimum required thickness”.

As a non-limiting example, if a film manufactured from all-virgin materials exhibits a tensile strength of X at a film thickness of 15 microns, and a recycled-plastic-containing film must have a minimum thickness of at least 25 microns to have a tensile strength of X, then 25 microns is the recycled-plastic-containing film's “minimum required thickness.”

There remains a need for reducing a recycled-plastic-containing film's minimum required thickness.

Regarding manufacturing of plastic films from all-virgin or prime raw materials, there remains a need to reduce the amount of virgin or prime raw materials being used during production; this will reduce the carbon footprint of the manufacturing process and can be achieved by introducing PCR plastic or PIR plastic into all-virgin or prime raw-material formulations. Also, the minimum thickness that is needed for an all-virgin-raw-material film to have the required physical properties for a particular end-use application is the all-virgin-raw-material film's “minimum required thickness.”

### BRIEF SUMMARY OF THE INVENTION

A product produced by a process having the step of creating a compounded product by compounding a composition having a formulation that includes: a first component that is a virgin-plastic-resin composition, a second component that is a composition that is a post-consumer recycled plastic resin, a post-industrial recycled plastic resin, or a combination thereof, and a third component that is a compound having the structure:

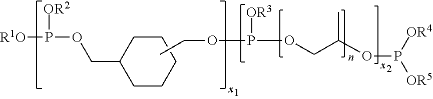

wherein each R¹, R², R³, R⁴ and R⁵ is independently selected and is a C₁₀-C₁₈ alkyl moiety; n is an integer ranging from 3 to 11; and the sum of X₁+X₂ is an integer ranging from 1-500.

A process having the step of creating a compounded product by compounding a composition having a formulation that includes: a first component that is a virgin-plastic-resin composition, a second component that is a composition that is a post-consumer recycled plastic resin, a post-industrial recycled plastic resin, or a combination thereof, and a third component that is a compound having the structure:

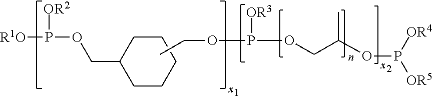

wherein each R¹, R², R³, R⁴ and R⁵ is independently selected and is a C₁₀-C₁₈ alkyl moiety; n is an integer ranging from 3 to 11; and the sum of X₁+X₂ is an integer ranging from 1-500.

A product produced by a process having the steps of creating a compounded product by compounding an all-virgin-raw-material formulation that includes: a first component that is a virgin-plastic-resin composition, and a second component that is a compound having the structure:

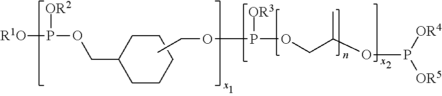

wherein each R¹, R², R³, R⁴ and R⁵ is independently selected and is a C₁₀-C₁₈ alkyl moiety; n is an integer ranging from 3 to 11; and the sum of X₁+X₂ is an integer ranging from 1-500, wherein the all-virgin-raw-material formulation does not include a post-consumer recycled plastic resin, a post-industrial recycled plastic resin, or a combination thereof, and manufacturing a film using the compounded product, wherein the film has at least a 5% reduction in the minimum required thickness relative to an all-virgin-raw-material film that does not include the second component but has been otherwise prepared using the same formulation and the same process.

A product produced by a process having the step of creating a compounded product by compounding a composition having a formulation that includes: a first component that is a composition that is a post-consumer recycled plastic resin, a post-industrial recycled plastic resin, or a combination thereof, and a second component that is a compound having the structure:

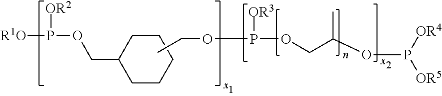

wherein each R¹, R², R³, R⁴ and R⁵ is independently selected and is a C₁₀-C₁₈ alkyl moiety; n is an integer ranging from 3 to 11; and the sum of X₁+X₂ is an integer ranging from 1-500.

### BRIEF DESCRIPTION OF THE SEVERAL VIEWS OF THE DRAWING(S)

FIG. 1 is an illustration of experimental results.

FIG. 2 is an illustration of experimental results.

FIG. 3 is an illustration of experimental results.

### DETAILED DESCRIPTION OF THE INVENTION

Embodiments are directed to a plastic film manufactured from a compounded composition having the following components in its formulation:
i) a first component that is a virgin plastic resin,
ii) a second component that is a post-consumer recycled (PCR) plastic resin, a post-industrial recycled (PIR) plastic resin, or a combination thereof, and
iii) a third component that is a compound having the structure:

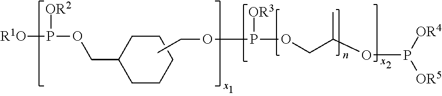

wherein
   each R¹, R², R³, R⁴ and R⁵ is independently selected and is a C₁₀-C₁₈ alkyl moiety;
   n is an integer ranging from 3 to 11; and
   the sum of X₁+X₂ is an integer ranging from 1-500.

A virgin plastic resin is a resin that has not yet been used in manufacturing and may also received from a resin manufacturer or distributor. Non-limiting examples of types of useful virgin plastic resins include: polypropylene, polyethylene, high density polyethylene, low density polyethylene, linear low density polyethylene, medium density polyethylene, polyolefin polymers, polyolefin copolymers, polypropylene-polyethylene copolymers, and combinations thereof.

Useful virgin plastic resins are commercially available and widely distributed.

In an embodiment, a virgin plastic resin can be present in a PCR-plastic-containing or a PIR-plastic-containing formulation in an amount ranging from 29% to 95% by weight. In another embodiment, a virgin plastic resin can be present in a PCR-plastic-containing or a PIR-plastic-containing formulation in an amount ranging from 60% to 90% by weight. In still another embodiment, a virgin plastic resin can be present in a PCR-plastic-containing or a PIR-plastic-containing formulation in an amount ranging from 70% to 85% by weight.

Non-limiting examples of types of useful PCR-plastic resins and PIR-plastic resins include: polypropylene, polyethylene, high density polyethylene, low density polyethylene, linear low density polyethylene, medium density polyethylene, polyolefin polymers, polyolefin copolymers, polypropylene-polyethylene copolymers, or combinations thereof.

Useful PCR plastic resins and PIR plastic resins are commercially available and widely distributed. In embodiments, PCR plastic resins and PIR plastic resins are dried prior to compounding (in an effort to reduce the water content within the resin).

In an embodiment, a PCR plastic resin, PIR plastic resin, or combination thereof can be present in a formulation in an amount ranging from 4% to 70% by weight. In another embodiment, a PCR plastic resin, PIR plastic resin, or combination thereof can be present in a formulation in an amount ranging from 10% to 40% by weight. In still another embodiment, a PCR plastic resin, PIR plastic resin, or combination thereof can be present in a formulation in an amount ranging from 15% to 30% by weight.

A useful compound for reducing a film's minimum required thickness has the structure:

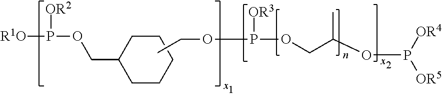

wherein
   each R¹, R², R³, R⁴ and R⁵ is independently selected and is a C₁₀-C₁₈ alkyl moiety;
   n is an integer ranging from 3 to 11; and
   the sum of X₁+X₂ is an integer ranging from 1-500.

The above molecule can either be obtained commercially, or manufactured using known methods, without having to exercise undue experimentation.

In an embodiment, a molecule having the above chemical structure can be present in a formulation in an amount ranging from 0.01% by weight to 5% by weight. In another embodiment, a molecule having the above chemical structure can be present in a formulation in an amount ranging from 0.025% by weight to 0.25% by weight.

Additives and fillers, known to be useful in film manufacturing, can be used in PCR- and PIR-plastic-containing film-formulation embodiments in amounts known to be useful and without having to exercise undue experimentation. Additives and fillers are commercially available and widely distributed.

PCR- and PIR-plastic-containing film-formulation compositional embodiments can be compounded using any known compounding method. Non-limiting examples of useful compounding methods include: banbury-mixer compounding, single-screw compounding, twin-screw compounding that includes co-rotating and counter-rotating twin-screw compounding.

Plastic films can be manufactured using known extrusion methods that include both blown and cast-film manufacturing methods.

In PCR- and PIR-plastic-containing film embodiments manufactured from a compounded composition having the following components in its formulation:
i) a first component that is a virgin-plastic-resin,
ii) a second component that is a PCR plastic resin, a PIR plastic resin, or a combination thereof, and
iii) a third component that is a compound having the structure:

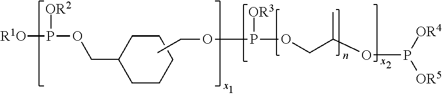

wherein
   each R¹, R², R³, R⁴ and R⁵ is independently selected and is a C₁₀-C₁₈ alkyl moiety;
   n is an integer ranging from 3 to 11; and
   the sum of X₁+X₂ is an integer ranging from 1-500,

a film has a reduction in the minimum required thickness relative to a PCR- and PIR-plastic-containing film that does not include the third component but has been otherwise prepared using the same formulation and by the same or substantially the same process. In other embodiments, a film has at least a 5% reduction in the minimum required thickness relative to a PCR- or PIR-plastic-containing film that does not include the third component but has been otherwise prepared using the same formulation and by the same or substantially the same process. In other embodiments, a film has at least a 10% reduction in the minimum required thickness relative to a PCR- or PIR-plastic-containing film that does not include the third component but has been otherwise prepared using the same formulation and by the same or substantially the same process. In still other embodiments, a film has at least a 15% reduction in the minimum required thickness relative to a PCR- or PIR-plastic-containing film that does not include the third component but has been otherwise prepared using the same formulation and by the same or substantially the same process. In still other embodiments, a film has at least a 20% reduction in the minimum required thickness relative to a PCR- or PIR-plastic-containing film that does not include the third component but has been otherwise prepared using the same formulation and by the same or substantially the same process.

In PCR- and PIR-plastic-containing film embodiments manufactured from a compounded composition having the following components in its formulation:
i) a first component that is a virgin-plastic-resin composition,
ii) a second component that is a PCR plastic resin, a PIR plastic resin, or a combination thereof, and
iii) a third component that is a compound having the structure:

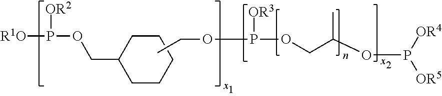

wherein
   each R¹, R², R³, R⁴ and R⁵ is independently selected and is a C₁₀-C₁₈ alkyl moiety;
   n is an integer ranging from 3 to 11; and
   the sum of X₁+X₂ is an integer ranging from 1-500,

a film has a reduced gel count per unit area relative to a PCR- or PIR-plastic-containing film that does not include the third component but has been otherwise prepared using the same formulation and by the same or substantially the same process. In other embodiments, a film has at least a 5% reduction in the gel count per unit area relative to a PCR- or PIR-plastic-containing film that does not include the third component but has been otherwise prepared using the same formulation and by the same or substantially the same process. In other embodiments, a film has at least a 10% reduction in the gel count per unit area relative to a PCR- or PIR-plastic-containing film that does not include the third component but has been otherwise prepared using the same formulation and by the same or substantially the same process. In still other embodiments, a film has at least a 15% reduction in the gel count per unit area relative to a PCR- or PIR-plastic-containing film that does not include the third component but has been otherwise prepared using the same formulation and by the same or substantially the same process.

In PCR- and PIR-plastic-containing film embodiments manufactured from a compounded composition having the following components in its formulation:
i) a first component that is a virgin-plastic-resin composition,
ii) a second component that is a PCR plastic resin, a PIR plastic resin, or a combination thereof, and
iii) a third component that is a compound having the structure:

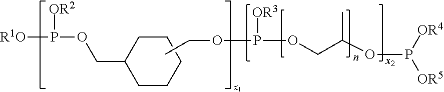

wherein
   each R¹, R², R³, R⁴ and R⁵ is independently selected and is a C₁₀-C₁₈ alkyl moiety;
   n is an integer ranging from 3 to 11; and
   the sum of X₁+X₂ is an integer ranging from 1-500,

a film has an increased tensile strength relative to a PCR- or PIR-plastic-containing film that does not include the third component but has been otherwise prepared using the same formulation and by the same or substantially the same process. In other embodiments, a film has at least a 5% increase in tensile strength relative to a PCR- or PIR-plastic-containing film that does not include the third component but has been otherwise prepared using the same formulation and by the same or substantially the same process. In other embodiments, a film has at least a 10% increase in tensile strength relative to a PCR or PIR plastic-containing film that does not include the third composition but has been otherwise prepared using the same formulation and by the same or substantially the same process.

Useful film products that can be manufactured using the film embodiments include: a garbage bag, a merchandise bag, an agricultural or geomembrane film, industrial packaging, a shipping sack or bag, stretch or shrink wrap film, a food packaging film or bag, a stand-up pouch, a sandwich bag or freezer bag.

Other inventive embodiments are directed to a plastic film manufactured from an all-virgin compounded film formulation that does not include a PCR or PIR plastic resin; these all-virgin compounded film formulation embodiments are manufactured from a compounded composition having the following components in its formulation:
i) a first component that is a virgin-plastic resin, and
ii) a second component that is a compound having the structure:

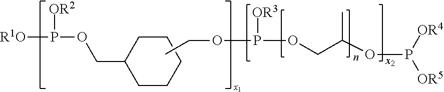

wherein
   each R¹, R², R³, R⁴ and R⁵ is independently selected and is a C₁₀-C₁₈ alkyl moiety;
   n is an integer ranging from 3 to 11; and
   the sum of X₁+X₂ is an integer ranging from 1-500.

Again, for clarity, the all-virgin embodiments do not include a PCR or PIR plastic resin in the compounded composition's formulation.

In an embodiment, a virgin-plastic resin can be present in an all-virgin compounded film formulation in an amount ranging from 60% to 99% by weight. In another embodiment, a virgin-plastic resin can be present in an all-virgin compounded film formulation in an amount ranging from 70% to 99% by weight.

In an embodiment, a molecule having the above chemical structure, i.e., the second component, can be present in an all-virgin compounded film formulation in an amount ranging from 0.01% by weight to 5% by weight. In another embodiment, a molecule having the above chemical structure can be present in an all-virgin compounded film formulation in an amount ranging from 0.025% by weight to 0.25% by weight.

Additives and fillers known to be useful in film manufacturing, can be used in all-virgin compounded film formulation embodiments in amounts known to be useful and without having to exercise undue experimentation. Additives and fillers are commercially available and widely distributed.

All-virgin compounded film formulation embodiments can be compounded using any known compounding method. Non-limiting examples of useful compounding methods include: banbury-mixer compounding, single-screw compounding, twin-screw compounding that includes co-rotating and counter-rotating twin-screw compounding.

Plastic films can be manufactured using known extrusion methods that include both blown and cast-film manufacturing methods.

In all-virgin film embodiments manufactured from a compounded composition having the following components in its formulation:
i) a first component that is a virgin-plastic resin, and
ii) a second component that is a compound having the structure:

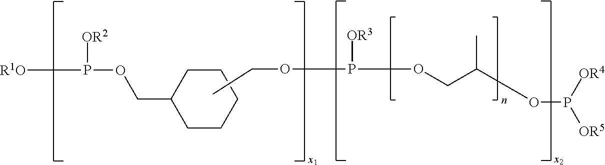

wherein
   each R¹, R², R³, R⁴ and R⁵ is independently selected and is a C₁₀-C₁₈ alkyl moiety;
   n is an integer ranging from 3 to 11; and
   the sum of X₁+X₂ is an integer ranging from 1-500,

films have a reduction in the minimum required thickness relative to an all-virgin film that does not include the second component but has been otherwise prepared using the same formulation and by the same or substantially the same process. In other embodiments, films have at least a 5% reduction in the minimum required thickness relative to an all-virgin film that does not include the second component but has been otherwise prepared using the same formulation and by the same or substantially the same process. In other embodiments, films have at least a 10% reduction in the minimum required thickness relative to an all-virgin film that does not include the second component but has been otherwise prepared using the same formulation and by the same or substantially the same process.

Useful film products that can be manufactured using the all-virgin film embodiments include: a garbage bag, a merchandise bag, an agricultural or geomembrane film, industrial packaging, a shipping sack or bag, stretch or shrink wrap film, a food packaging film or bag, a stand-up pouch, a sandwich bag or freezer bag.

In additional embodiments, and as shown in the following Examples 1 and 2, a compounded composition having the following components in its formulation:
i) a first component that is a PCR plastic resin, a PIR plastic resin, or a combination thereof, and
ii) a second component that is a compound having the structure:

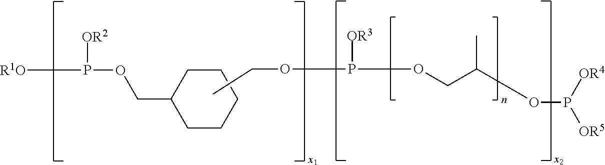

wherein
   each R¹, R², R³, R⁴ and R⁵ is independently selected and is a C₁₀-C₁₈ alkyl moiety;
   n is an integer ranging from 3 to 11; and
   the sum of X₁+X₂ is an integer ranging from 1-500,

has a more stabilized melt flow rate after a third extrusion pass using an extrusion-pass method, relative to: a PCR plastic resin, a PIR plastic resin, or a combination thereof that does not include the second component but is otherwise the same and which has also been passed three times using the same extrusion-pass method. In embodiments, the compounded composition has a melt flow rate that is at least 5% more stable after a third extrusion pass using an extrusion-pass method, relative to: a PCR plastic resin, a PIR plastic resin, or a combination thereof that does not include the second component but is otherwise the same and which has also been passed three times using the same extrusion-pass method. In embodiments, the compounded composition has a melt flow rate that is at least 10% more stable after a third extrusion pass using an extrusion-pass method, relative to: a PCR plastic resin, a PIR plastic resin, or a combination thereof that does not include the second component but is otherwise the same and which has also been passed three times using the same extrusion-pass method. In embodiments, the compounded composition has a melt flow rate that is at least 15% more stable after a third extrusion pass using an extrusion-pass method, relative to: a PCR plastic resin, a PIR plastic resin, or a combination thereof that does not include the second component but is otherwise the same and which has also been passed three times using the same extrusion-pass method.

Extrusion-pass methods are well known in the art and are commonly used in testing to assess a resin composition's or compounded product's melt flow rate stability after one or more extrusion passes. Each extrusion pass adds an additional heat history to the composition or compounded product and therefore helps in assessing the composition's or product's melt flow rate stability after each additional extrusion pass or heat history. Any known extrusion-pass method can be employed.

In still other embodiments, and as shown in the following Examples 3 and 4, a compounded composition having the following components in its formulation:
i) a first component that is a PCR plastic resin, a PIR plastic resin, or a combination thereof, and
ii) a second component that is a compound having the structure:

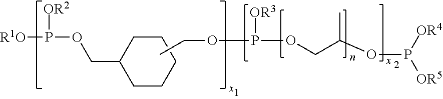

wherein
   each R¹, R², R³, R⁴ and R⁵ is independently selected and is a C₁₀-C₁₈ alkyl moiety;
   n is an integer ranging from 3 to 11; and
   the sum of X₁+X₂ is an integer ranging from 1-500,

has a more stabilized melt flow rate after being repelletized using a repelletization method, relative to: a PCR plastic resin, a PIR plastic resin, or a combination thereof that does not include the second component but is otherwise the same and which has also been repelletized using the same repelletization method. In embodiments, the compounded composition has a melt flow rate that is at least 5% more stable after being repelletized using a repelletization method, relative to: a PCR plastic resin, a PIR plastic resin, or a combination thereof that does not include the second component but is otherwise the same and which has also been repelletized using the same repelletization method. In embodiments, the compounded composition has a melt flow rate that is at least 10% more stable after being repelletized using a repelletization method, relative to: a PCR plastic resin, a PIR plastic resin, or a combination thereof that does not include the second component but is otherwise the same and which has also been repelletized using the same repelletization method. In embodiments, the compounded composition has a melt flow rate that is at least 15% more stable after being repelletized using a repelletization method, relative to: a PCR plastic resin, a PIR plastic resin, or a combination thereof that does not include the second component but is otherwise the same and which has also been repelletized using the same repelletization method.

Repelletization methods are well known in the art and are commonly used in testing to assess a resin composition's or compounded product's melt flow rate stability after being repelletized. A repelletization method necessarily adds an additional heat history to a composition or product and therefore helps in assessing the composition's or product's melt flow rate stability after the additional heat history. Any known repelletization method can be employed.

In embodiments, in a compounded composition having the following components in its formulation:
i) a first component that is a PCR plastic resin, a PIR plastic resin, or a combination thereof, and
ii) a second component that is a compound having the structure:

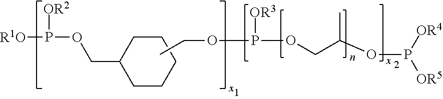

wherein
   each R¹, R², R³, R⁴ and R⁵ is independently selected and is a C₁₀-C₁₈ alkyl moiety;
   n is an integer ranging from 3 to 11; and
   the sum of X₁+X₂ is an integer ranging from 1-500,

the second component can be present in a formulation in an amount ranging from 0.01% by weight to 5% by weight. In another embodiment, the second component can be present in a formulation in an amount ranging from 0.025% by weight to 0.25% by weight.

### EXAMPLES

### Example 1

The stability of 100% PCR LLDPE resin was evaluated by a multiple pass extrusion. A control formulation containing no additional stabilizer was compared to formulations containing the polymeric phosphite. For each formulation, the polymer was processed for five extrusion passes at 245 C and MFR was measured after each pass. The polymeric phosphite was introduced using a LLDPE masterbatch containing 2.5% of the polymeric phosphite, 2.5% hindered phenolic stabilizer, and 0.5% hydrotalcite. The PCR resin was stabilized by the addition of 1% masterbatch pellets in one formulation and 2% masterbatch pellets in a second formulation.

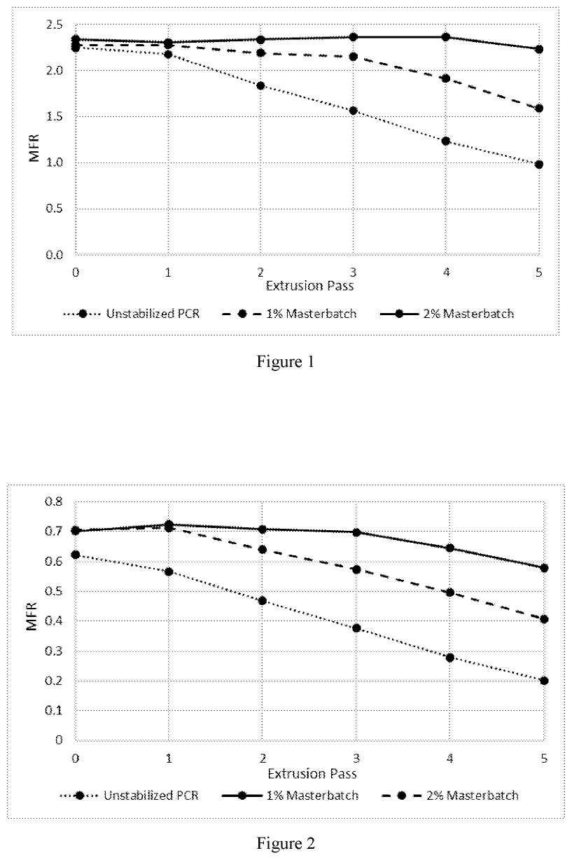

Both formulations containing the polymeric phosphite maintained the starting MFR better than the formulation containing no polymeric phosphite. See FIG. 1.

The stability of the formulations was also evaluated by OIT (Oxygen Induction Time). OIT was run according to ASTM D3895 on the polymer after 4 extrusion passes. The time in minutes is measured until an exothermic event is detected by the DSC. A longer amount of time indicates improved stability. Both formulations containing the polymeric phosphite show improved stability versus the control formulation.

| Description | OIT (min) |
|---|---|
| Unstabilized PCR Resin | 7.9 |
| PCR Resin stabilized with 1% masterbatch | 10.3 |
| PCR Resin stabilized with 2% masterbatch | 20.9 |

### Example 2

The stability of 100% PCR LDPE resin was evaluated by a multiple pass extrusion. A control formulation containing no additional stabilizer was compared to formulations containing the polymeric phosphite. For each formulation, the polymer was processed for five extrusion passes at 220 C and MFR was measured after each pass. The polymeric phosphite was introduced using a LLDPE masterbatch containing 2.5% of the polymeric phosphite, 2.5% hindered phenolic stabilizer, and 0.5% hydrotalcite. The PCR resin was stabilized by the addition of 1% masterbatch pellets in one formulation and 2% masterbatch pellets in a second formulation.

Both formulations containing the polymeric phosphite maintained the starting MFR better than the formulation containing no polymeric phosphite. See FIG. 2.

The stability of the formulations was also evaluated by OIT (Oxygen Induction Time). OIT was run according to ASTM D3895 on the polymer after 4 extrusion passes. The time in minutes is measured until an exothermic event is detected by the DSC. A longer amount of time indicates improved stability. Both formulations containing the polymeric phosphite show improved stability versus the control formulation.

| Description | OIT (min) |
|---|---|
| Unstabilized PCR Resin | 2.5 |
| PCR Resin stabilized with 1% masterbatch | 3.6 |
| PCR Resin stabilized with 2% masterbatch | 6.4 |

The improved stability of the polymer seen by MFR and OIT testing in Example 1 and Example 2 indicate less crosslinking and degradation is occurring in the PCR when it is stabilized by the polymeric phosphite. When this stabilized PCR resin is combined with virgin resin to produce films, the improved stability will result in lower gel counts in the film.

Large gels in cast and blown film lead to weak areas and lower the tensile strength of the film. Reducing the number of these gels increases the strength of the film and allows for the use of thinner films.

### Example 3

Melt flow rate of PCR LLDPE was tested to show the improved stability during melt processing. The MFR of the PCR was measured at 2.2 before processing it through the repelletizer. 3 resin samples were loaded with the polymeric phosphite and processed through the repelletizer, and the MFR results were compared to a resin sample with no additional stabilizer. All three samples containing the polymeric phosphite maintained the original MFR stability while the sample with no stabilizer had a large reduction in MFR. LLDPE crosslinks when it degrades causing the MFR to decrease, the cross-linked polymer causes an increase gel counts when film is produced.

| LLDPE | Polymeric Phosphite ppm | MFR |
|---|---|---|
| Unprocessed Resin | 0 | 2.2 |
| Processed resin 1 | 0 | 1.1 |
| Processed resin 2 | 3200 | 2.2 |
| Processed resin 3 | 2400 | 2.1 |
| Processed resin 4 | 1600 | 2.4 |

The melt temperature of processed resin 1 was measured at 220 C while the resins containing the polymeric phosphite had a melt temperature of 200 C. All of the formulations were processed under the same extruder conditions, so the decrease in melt temperature indicates a reduction of shear heating during extrusion.

The pressure during processing was 10% lower when the polymeric phosphite was present compared to the formulation with no polymeric phosphite.

### Example 4

Melt flow rate of PCR LDPE was tested to show the improved stability during melt processing. The MFR of the PCR was measured at 0.35 before processing it through the repelletizer. 2 resin samples were loaded with the polymeric phosphite and processed through the repelletizer, and the MFR results were compared to a resin sample with no additional stabilizer. Both resin samples containing the polymeric phosphite maintained the original MFR stability while the sample with no stabilizer had a large reduction in MFR. LDPE crosslinks when it degrades causing the MFR to decrease, the cross-linked polymer causes an increase in gel counts when the film is produced.

| LDPE | Polymeric Phosphite ppm | MFR |
|---|---|---|
| Unprocessed Resin | 0 | 0.35 |
| Processed resin 1 | 0 | 0.22 |
| Processed resin 2 | 800 | 0.35 |
| Processed resin 3 | 1600 | 0.39 |

### Example 5

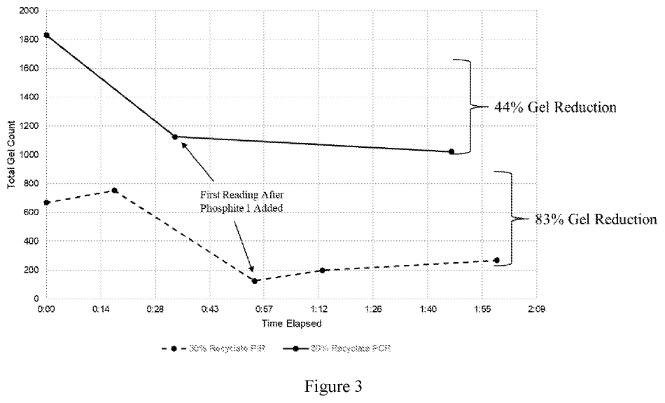

LLDPE was processed on a cast film line at about 800 kg/hr. One formulation contained 70% virgin resin and 30% post consumer waste, and the other contained 70% virgin resin and 30% post industrial waste. The formulations were initially run with no addition of the polymeric phosphite. After 30-60 minutes of processing, the polymeric phosphite was injected into the repelletizer using a liquid feed pump. The PCR and PIR pellets were then used to produce cast film. Gel count data was measured on the film before the polymeric phosphite was added to the PCR and PIR and after it was added. The cast film produced from the PIR and PCR showed a large decrease in gel counts upon addition of the polymeric phosphite. See FIG. 3.

### Example 6

LLDPE containing 25-30% PCR was produced on a cast film line. Gel count measurements were taken at various time intervals up to 51 hours. The polymeric phosphite was introduced into the film line after 46 hours of processing and the first gel count measurement of film containing the polymeric phosphite was taken at 47.5 hours. The addition of the polymeric phosphite nearly eliminated the large gels with a size over 1600 microns. Large gels are the most problematic since these cause imperfections in the film, which can reduce the tensile strength. Thicker films may need to be produced in order to overcome the reduced tensile strength.

| | |
|---|---|
| Time | Gel Count by Size (Microns) |

| (h) | % PCR | <800 | 800-1600 | 1600-2400 | >2400 |
|---|---|---|---|---|---|
| 0 | 25% | 5064 | 102 | 14 | 33 |
| 8 | 25% | 1417 | 46 | 32 | 96 |
| 20 | 25% | 719 | 21 | 7 | 24 |
| 32 | 25% | 709 | 9 | 2 | 2 |
| 44 | 25% | 2633 | 46 | 1 | 10 |
| 46 | 30% | 923 | 95 | 13 | 52 |
| 47.5 | 30% | 1358 | 40 | 0 | 0 |
| 47.8 | 30% | 1259 | 31 | 0 | 0 |
| 48 | 30% | 2062 | 41 | 1 | 0 |
| 50 | 30% | 1521 | 7 | 0 | 0 |
| 51 | 30% | 358 | 5 | 0 | 0 |

What is claimed is:

1. A product produced by a process having the step:
creating a compounded product by compounding a composition having a formulation that includes:
a first component that is a virgin-plastic-resin composition,
a second component that is a composition that is a post-consumer recycled plastic resin, a post-industrial recycled plastic resin, or a combination thereof, and
a third component that is a compound having the structure: 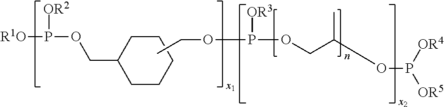
wherein
each R¹, R², R³, R⁴ and R⁵ is independently selected and is a C₁₀-C₁₈ alkyl moiety;
n is an integer ranging from 3 to 11; and
the sum of X₁+X₂ is an integer ranging from 1-500.

2. The product produced by a process of claim 1, wherein the first component is in the formulation in an amount ranging from 29% by weight to 95% by weight.

3. The product produced by a process of claim 1, wherein the second component is in the formulation in an amount ranging from 4% by weight to 70% by weight.

4. The product produced by a process of claim 1, wherein the third component is in the formulation in an amount ranging from 0.01% by weight to 5% by weight.

5. The product produced by a process of claim 1, wherein the third component is in the formulation in an amount ranging from 0.025% by weight to 0.25% by weight.

6. The product produced by a process of claim 1, wherein the process further comprises the step:
extruding the compounded product.

7. The product produced by a process of claim 1, wherein the process further comprises the step:
manufacturing a film using the compounded product.

8. The product produced by a process of claim 7, wherein the film is a garbage bag, a merchandise bag, an agricultural or geomembrane film, industrial packaging, a shipping sack or bag, stretch or shrink wrap film, a food packaging film or bag, a stand-up pouch, a sandwich bag or freezer bag.

9. The product produced by a process of claim 7, wherein the film has at least a 5% reduced gel count per unit area relative to a film of the same thickness that does not include the third component but has been otherwise prepared using the same formulation and the same process.

10. The product produced by a process of claim 7, wherein the film has at least a 5% reduction in the minimum required thickness relative to a film that does not include the third component but has been otherwise prepared using the same formulation and by the same process.

11. The product produced by a process of claim 7, wherein the film has at least a 5% increase in tensile strength relative to a film that does not include the third component but has been otherwise prepared using the same formulation and the same process.

12. A process having the step:
creating a compounded product by compounding a composition having a formulation that includes:
a first component that is a virgin-plastic-resin composition,
a second component that is a composition that is a post-consumer recycled plastic resin, a post-industrial recycled plastic resin, or a combination thereof, and
a third component that is a compound having the structure: 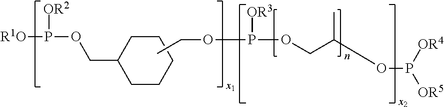
wherein
each R¹, R², R³, R⁴ and R⁵ is independently selected and is a C₁₀-C₁₈ alkyl moiety;
n is an integer ranging from 3 to 11; and
the sum of X₁+X₂ is an integer ranging from 1-500.

13. The process of claim 12, wherein the first component is in the formulation in an amount ranging from 29% by weight to 95% by weight.

14. The process of claim 12, wherein the second component is in the formulation in an amount ranging from 4% by weight to 70% by weight.

15. The process of claim 12, wherein the third component is in the formulation in an amount ranging from 0.01% by weight to 5% by weight.

16. The process of claim 12, wherein the third component is in the formulation in an amount ranging from 0.025% by weight to 0.25% by weight.

17. The process of claim 12, wherein the process further comprises the step:
extruding the compounded product.

18. The process of claim 12, wherein the process further comprises the step:
manufacturing a film using the compounded product.

19. The process of claim 18, wherein the film is a garbage bag, a merchandise bag, an agricultural or geomembrane film, industrial packaging, a shipping sack or bag, stretch or shrink wrap film, a food packaging film or bag, a stand-up pouch, a sandwich bag or freezer bag.

20. The process of claim 18, wherein the film has at least a 5% reduced gel count per unit area relative to a film of the same thickness that does not include the third component but has been otherwise prepared using the same formulation and the same process.

21. The process of claim 18, wherein the film has at least a 5% reduction in the minimum required thickness relative to a film that does not include the third component but has been otherwise prepared using the same formulation and the same process.

22. The process of claim 18, wherein the film has at least a 5% increase in tensile strength relative to a film that does not include the third component but has been otherwise prepared using the same formulation and the same process.

23. A product produced by a process having the steps:
creating a compounded product by compounding an all-virgin-raw-material formulation that includes:
a first component that is a virgin-plastic-resin composition, and
a second component that is a compound having the structure: 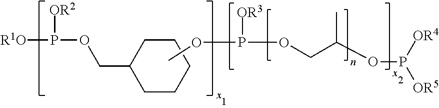
wherein
each R¹, R², R³, R⁴ and R⁵ is independently selected and is a C₁₀-C₁₈ alkyl moiety;
n is an integer ranging from 3 to 11; and
the sum of X₁+X₂ is an integer ranging from 1-500,
wherein the all-virgin-raw-material formulation does not include a post-consumer recycled plastic resin, a post-industrial recycled plastic resin, or a combination thereof, and
manufacturing a film using the compounded product,
wherein the film has at least a 5% reduction in the minimum required thickness relative to an all-virgin-raw-material film that does not include the second component but has been otherwise prepared using the same formulation and the same process.

24. A product produced by a process having the step:
creating a compounded product by compounding a composition having a formulation that includes:
a first component that is a composition that is a post-consumer recycled plastic resin, a post-industrial recycled plastic resin, or a combination thereof, and
a second component that is a compound having the structure: 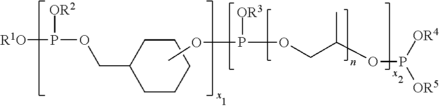
wherein
each R¹, R², R³, R⁴ and R⁵ is independently selected and is a C₁₀-C₁₈ alkyl moiety;
n is an integer ranging from 3 to 11; and
the sum of X₁+X₂ is an integer ranging from 1-500.

25. The product produced by a process of claim 24, wherein the compounded product has a more stabilized melt flow rate after three extrusion passes using an extrusion-pass method, relative to: a PCR plastic resin, a PIR plastic resin, or a combination thereof that does not include the second component but is otherwise the same and which has also been passed three times using the same extrusion-pass method.

26. The product produced by a process of claim 24, wherein the compounded product has a more stabilized melt flow rate after being repelletized using a repelletization method, relative to: a PCR plastic resin, a PIR plastic resin, or a combination thereof that does not include the second component but is otherwise the same and which has also been repelletized using the same repelletization method.
